(19) United States
(12) Patent Application Publication
(10) Pub. No.: US 2010/0157376 A1
(43) Pub. Date: Jun. 24, 2010

(54) METHOD AND SYSTEM FOR INCREASING EDGE SHARPNESS IN COLOR PRINTED IMAGES

(75) Inventors: Walter J. Kulpa, Trumbull, CT (US); John P. Miller, Shelton, CT (US); Lun Chan, New Fairfield, CT (US)

Correspondence Address: PITNEY BOWES INC., 35 WATERVIEW DRIVE, MSC 26-22, SHELTON, CT, 06484-3000, US

(73) Assignee: Pitney Bowes Inc., Stamford, CT (US)

(21) Appl. No.: 12/341,697

(22) Filed: Dec. 22, 2008

(51) Int. Cl. H04N 1/409; G06K 9/40

(52) U.S. Cl. 358/3.27; 382/266

(57) ABSTRACT

A device and method for enhancing edge sharpness and clarity of solid graphic shapes included in printed color images printed on low dot-per-inch color printers is presented. The improved printing is achieved by creating an additional image file, called a white file, which defines the solid graphic areas to be included in the printed image. This white file is combined with the data points in separate color image files to “cookie-cut” the alphanumeric characters and other solid shapes from the separate color image files created by the ripping process, leaving crisp sharp edges on alphanumeric characters and other solid graphic areas being superimposed on the printed color image.

### FIELD OF THE INVENTION

The present invention relates generally to digital color printing systems, and more particularly to improving print quality of color printed images with low dots-per-inch (DPI) ink jet and other digital color printers such as the economical color printers used in postage meters.

### BACKGROUND OF THE INVENTION

When printing images using digital color printers it is often desirable to print alphanumeric or other solid color shapes superimposed on a color picture. For example, when printing custom postage stamps it is desirable to print the postage amount and other postal authority required graphics on a personal picture, such as a child's first birthday party, to create a personalized postage stamp that can be used to send letters through the mail. These stamps are often printed on low cost color printers in a home or small office. Ink jet and other color printers use a fixed number of ink colors to produce printed color images. A typical example would be the use of a four color process which employs the subtractive primary colors of cyan, magenta, and yellow, along with a key color such as black. The four colors of this four color process are usually abbreviated as CMYK. Each color is printed by a different ink jet print head. The image that is to be printed by these print heads must first be digitized into an electronic image file. Then this electronic image file must be broken down to create separate image files, one for each of the four CMYK colors. The process of separating the color image file into the four separate image files is called “ripping”. These separate image files contain a bit-map or matrix of data points that correspond to the spots to be printed by the individual print heads at each printable location. The bit-map files contain a logical 1 or 0 in each location to tell the print head whether or not to print a spot at that location. These four bit-map files for the four colors (CMYK) contain the map of that particular color as it appears in the original color image. For reproducing colors that are mixtures of the cyan, magenta, yellow, and black inks, the ripping program that creates the separate files also determines what proportions of each of the inks need to be printed in a specific location to get the desired color. During the printing process the data from each of the C, M, Y, and K files is sequentially sent to their respective print head to be printed.

A wide range of colors is created by printing different numbers of spots of each color ink in an area and relying on the human eye's tendency to “average” the spots together to give an observer the impression that there are a wide range of colors. Some printers can change the size of the spots being printed at each location of the image. A printer that can change the size of these spots has distinct advantages. It can generate a more accurate color by controlling the amounts of each color ink printed at a location. A printer that cannot vary the spot size must print different numbers of equally sized spots of each ink color in a larger vicinity to produce a given color. Since the printer relies on the human eye to average the array of ink spots together to achieve a particular color, the array of same size dots are more noticeable and produce a less well defined print. This problem becomes even more noticeable as the resolution, or number of dots per inch (DPI) is reduced. In a fixed dot size printer the sharpness of the transition from one significantly different colored area to another is degraded during the color separation process, making transitions that should be sharp appear fuzzy. This blurring effect is shown in FIG. 1A-1C. FIG. 1A shows one color from a set of ripped image files used to print an image of an indicium that evidences payment of postage. FIG. 1B shows an enlarged view of the letter “P” appearing in the lower right corner of FIG. 1A. The blurring caused by the ripping process can be clearly seen on the edge 10 of the letter “P” in FIG. 1B. The blurred transition on the edge of the letter P is due to the ripping process. FIG. 1C shows how the edge 10, of the letter “P”, would appear without the blurring caused by the ripping process. This blurring of edges becomes objectionable to the observer when viewing the solid colored areas of words and numbers that may be superimposed on a picture such as in the words “First Class” or the postage amount in a postage stamp. The degradation of the transition is increased further as the printing resolution is decreased and becomes quite objectionable when using a low cost low resolution ink jet printer.

### SUMMARY OF THE INVENTION

The present invention alleviates the problems associated with the prior art and provides systems and methods for improving the sharpness of transitions between areas of different color when the printing is done on a low DPI color printer.

In accordance with the present invention, a printing system is provided that enhances the typical multi-color processes used in the prior art. The present invention can be used in a low or high DPI digital color printer, such as those used to print postal indicium, with fixed or variable spot size and employs standard ripping technology to create the color bit-map files used to drive the individual color print heads during the printing process. The present invention uses additional electronic files containing the alphanumeric and any other solid C, M, Y, K, or “white” areas to electronically cookie-cut those areas that create the blurring of edges out of the C, M, Y, and K ripped files. The “white” areas referred to are produced by the application of no ink which allows the color of the underlying medium, which is often white, to show through. These electronic color and white files, including the files produced by the ripping process and the additional files, contain an array of points stored electronically as a zero to indicate the absence of that color or a one to indicate the presence of that color at each printable location. For the simplest case of producing “white” alphanumeric characters on a continually varying color image, a “white” file is electronically generated containing information about the location of the alphanumeric characters. The white file contains a logical one in every location defining the location of the alphanumeric characters and a logical zero in all background locations. During the printing process, the data points in a particular color file are fed to an individual color print head through a logic circuit. The data points in the white file, corresponding to those in the individual color file, are also synchronously fed to this logic circuit. The logic prevents any ink from being printed at locations where the white file contains a logical one. This has the effect of “cookie-cutting” the alphanumeric characters, which are cleanly represented in the white file, from the background image contained in the ripped color files. This results in sharp edged alphanumeric characters that have no spurious color ink spots within them.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIGS. 1A, 1B and 1C illustrate one color of a set of ripped images to show the effects of the ripping process.

FIG. 2 illustrates a pictorial diagram depicting the creation of electronic data files for the simplest case of superimposing white characters on a continuously varying color image.

FIG. 3 illustrates a logic circuit used to drive an individual color ink jet head.

FIG. 4 illustrates an overall logic circuit used to drive the color print heads in a four color printing process.

FIG. 5 illustrates an embodiment where a single color is used for filling superimposed graphic areas with a color or pattern.

FIG. 6 illustrates a block diagram of a postage printing device which implements the present invention.

FIG. 7 illustrates a flow chart showing the processing steps performed by the processing unit in FIG. 6.

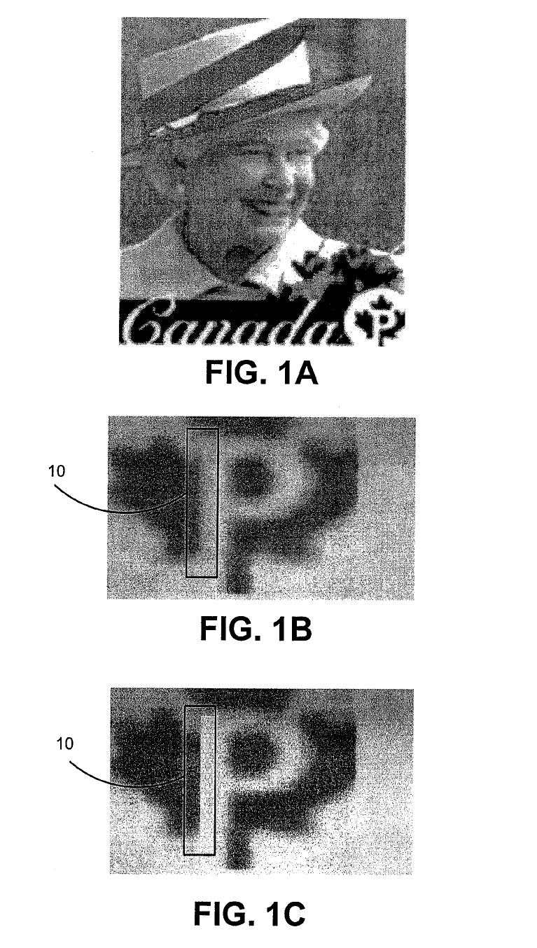

### DESCRIPTION OF THE PREFERRED EMBODIMENTS

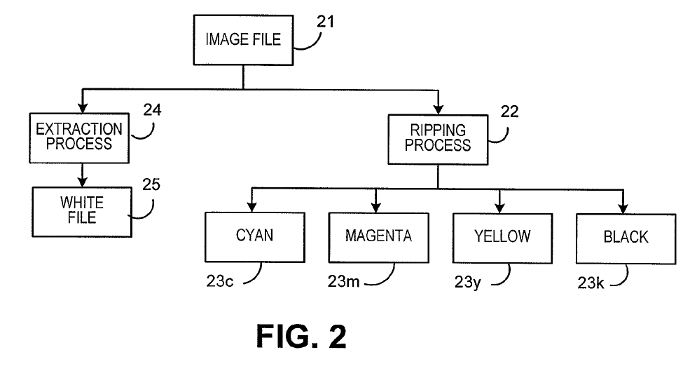

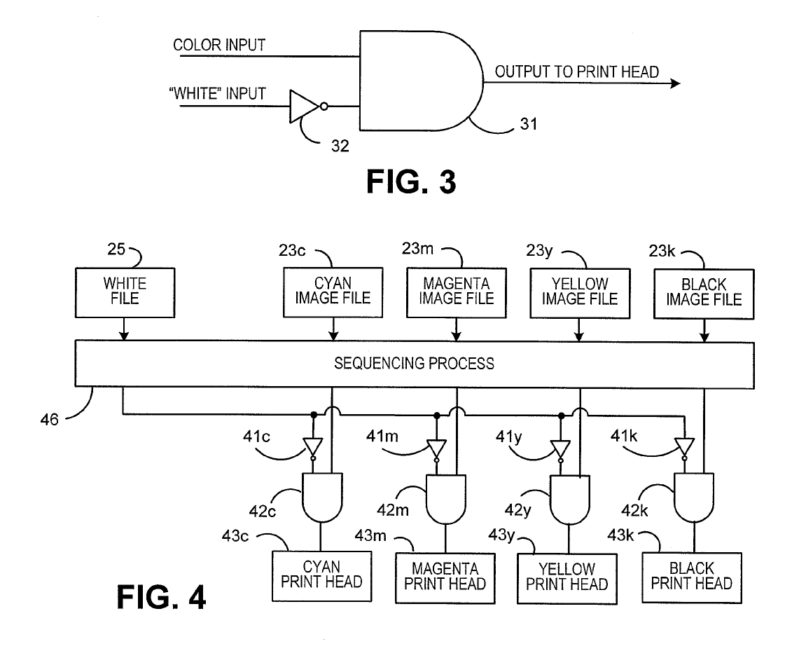

In describing the present invention, reference is made to the drawings, wherein there is seen in FIG. 2 a pictorial diagram depicting the creation of electronic data files for the simplest case of creating “white” characters on a continuously varying color image. Such white characters could be, for example, human readable elements that are provided over a color image, e.g., text in a color postage indicium. This processing begins by accepting an electronic image file 21 containing image data defining the color image that is to be printed. This electronic color image file may be in any of the industry standard image file formats, such as JPEG, TIFF, PNG, etc. or it may be in a custom format that contains the color image data necessary to define the desired image. The electronic image file 21 is then separated into individual color image files 23c, 23m, 23y, and 23k, by a ripping process 22, as is known in the art. There is one electronic color image file 23c, 23m, 23y, 23k, for each color ink used in the printing process; cyan, magenta, yellow and black in this example. Each of these electronic color image files contains a map of that particular color as it appears in the color image to be printed. In this preferred embodiment, the printing process uses the four subtractive color inks; cyan, magenta, yellow, and a key color of black. However it should be noted that this method applies equally well to other printing processes that use different numbers and colors of ink. An additional file 25 is created that contains the alphanumeric and other solid white areas to be superimposed on top of the original image. This “white” file can be extracted from the original image as is depicted in extraction process 24 or it can be created through separate processing steps as would be done to superimpose white lettering or other solid graphic shapes on a continuously varying color image. In either case the white file 25 contains data defining solid graphic areas that represent alphanumeric characters and other shapes to be printed on the color image. Each of these files 23c, 23m, 23y, 23k, and 25 contains an array of data points stored electronically as a one or a zero where each data point corresponds to a spot that will be printed by one of the color print heads. The data points use a logical one to indicate that a spot of that color should be printed at that location and a logical zero to indicate the absence of that color at that location. Referring now to FIG. 3, during the printing process, the data in a particular color image file, e.g., 23c, 23m, 23y or 23k, is fed to a corresponding individual color print head thru the input of AND gate 31. The data from the “white” file 25 corresponding to the data in the individual color file is fed to the input of NOT gate 32 that sends its input to the other input of AND gate 31. Table 1 shows the truth table of the logic circuit in FIG. 3. It should be noted that the data in any of the files can be inverted (logical ones changed to logical zeros and logical zeros changed to logical ones) and the truth table adjusted accordingly to achieve the same result. The output to the print head allows color to be printed only where the “White” input is zero. One of these logic circuits shown in FIG. 3 is used in the electrical connection between each color output from the ripping process and its respective color print head.

TABLE 1

| Color Input | “White” Input | Output to Print Head |
|---|---|---|
| 0 | 0 | 0 |
| 0 | 1 | 0 |
| 1 | 0 | 1 |
| 1 | 1 | 0 |

FIG. 4 shows the overall logic diagram for driving all four color print heads. The four CMYK color image files, 23c, 23m, 23y, 23k, and the White file 25, containing the clean alphanumeric image data are created using the method shown in FIG. 2 as described above. The sequencing process, 46, takes the data from the CMYK color image files and the data from the White file 25 and sends it to the individual color print heads 43c, 43m, 43y, 43k through a set of logic circuits like the one shown in FIG. 3. The sequencing process 46 outputs each data point in the color bit map files so that it will arrive at the print heads 43c, 43m, 43y, 43k, at the proper time for the print head to print a spot at the corresponding location on the media being printed. The print head will print a spot when the data it receives is a logical one and will not print a spot if the data is a logical zero. The sequencing process 46 also outputs data from the White file 25 so that each data point from the White file 25 arrives at the input of the NOT gates 41c, 41m, 41y, 41k, when the corresponding data point from the color image file arrives at the input to the AND gates 42c, 42m, 42y, 42k. The output from the AND gates 42c, 42m, 42y, 42k is then sent to the corresponding color print head 43c, 43m, 43y, 43k, so a spot can be printed. It can now be seen that the white file 25 prevents any ink from being printed in the solid graphic areas defined by the data contained therein. This results in clear alphanumeric characters and graphic shapes with sharp edges.

It should be noted that the white file 25 could also contain data to create a border that would eliminate the edge blur between the ripped color image files and the surrounding area. The data in the white file could also create a scalloped border to mimic the edges of a postage stamp. This method could also be applied to achieve a sharp transition between white areas and a neighboring color in the parent image. An example of this would be the transition between the white and red stripes or the white stars and the blue background in an image of the American flag. Also, since the White file 25 is a stand-alone file, the location of the alphanumeric and other solid graphic shapes can be moved around during image preparation so that they do not superimpose on any important features in the parent image.

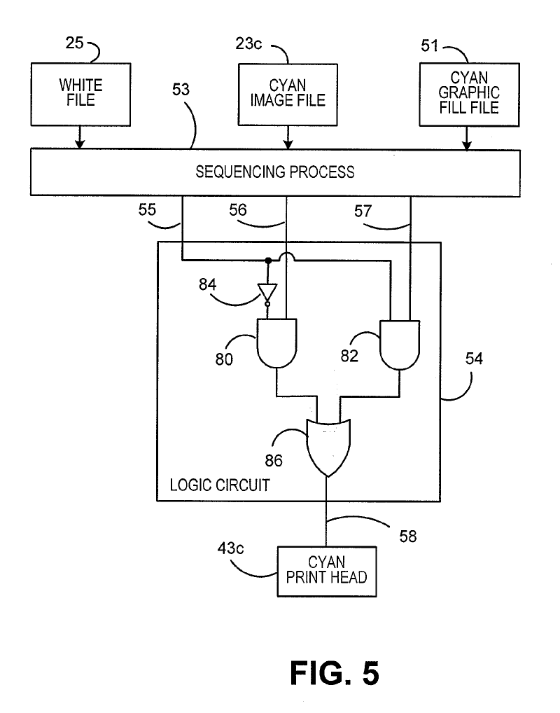

There are many instances where simply preventing the application of ink within the solid graphic areas is not desirable and it is preferable to fill the alphanumeric characters and shapes with a color or other pattern. For example, when the color of the underlying media is unknown or does not provide sufficient contrast between the solid graphic areas and the background image, filling the characters and shapes with a contrasting color or pattern increases readability. The simple case described above of using the “white” file to prevent the application of ink can be expanded to include a second set of color image files containing the colors to be printed inside the solid graphic areas contained in the “white” file. This second set of color files can contain data defining a solid color, a pattern, or border that is to be used to fill in the solid graphic areas defined in the “white” file. For the four color process described above this would entail creating four color fill files containing the map for each of the CMYK colors. FIG. 5 illustrates an embodiment where a single color, cyan, is used for filling a graphic area that would not have been printed in the embodiment described with respect to FIG. 4. As in the simple case described above, data from the white file 25 and the cyan image file 23c are fed to a logic circuit 54 by the sequencing process 53. In addition, the sequencing process 53 will feed the corresponding data from the cyan graphic fill file 51 to the logic circuit 54. Logic circuit 54 includes AND gates 80, 82, a NOT gate 84 having its output being input to a first input of the AND gate 80, and an OR gate 86 that has as its inputs the outputs from each of the AND gates 80, 82. The output 58 of logic circuit 54 will in turn be sent to the cyan print head 43c. Table 2 shows the truth table defining the output 58 of the circuit 54 for the various data combinations of its three inputs; the white input 55, the color input 56, and the fill input 57. The white input 55 is input to the NOT gate 84 and a first input of the AND gate 82. The color input 56 is input to the second input of the AND gate 80. The fill input 57 is input to the second input of the AND gate 82. The print head will print when a logic one is received. This circuit has the effect of printing an ink spot when the fill input 57 is a logic one and either of the color input 56 or the white file input 55 is a logic one, resulting in either the color image being printed or a solid graphic area being printed with the fill color. When the fill input 57 is a logic zero (indicating that the respective fill color is not to be used), then printing of an ink spot with the respective ink color will not occur whenever the white file input 55 is a logic one (indicating a solid graphic area that is either left unprinted or may be printed with a different color is present). Note that the logic values of any of the data files can be inverted and the truth table adjusted to achieve the same result. The circuit shown in FIG. 5 is duplicated for each of the other colors—magenta, yellow and black in this preferred embodiment—used in the printing process.

TABLE 2

| | | | Output to Print |
|---|---|---|---|
| “White” Input | Color Input | Fill input | Head |
| 0 | 0 | 0 | 0 |
| 0 | 0 | 1 | 0 |
| 0 | 1 | 0 | 1 |
| 0 | 1 | 1 | 1 |
| 1 | 0 | 0 | 0 |
| 1 | 0 | 1 | 1 |
| 1 | 1 | 0 | 0 |
| 1 | 1 | 1 | 1 |

Similar techniques could be used to produce alphanumeric and other graphics that would have outlines in one of the basic ink colors so that the information would be visible when it appeared on a white or a lightly colored area of the color image being printed.

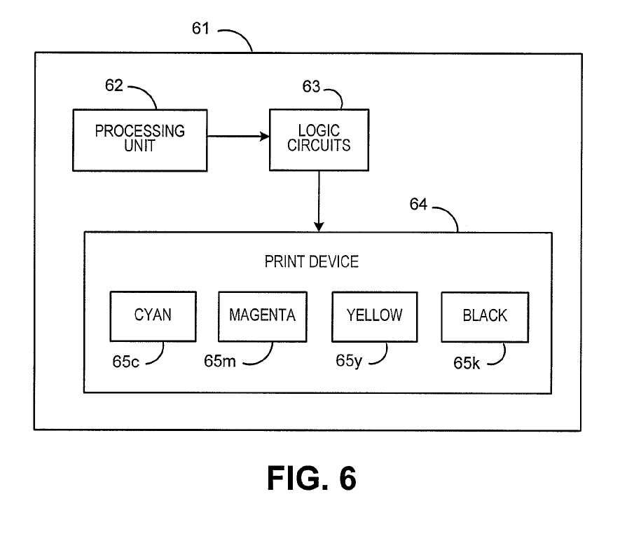

FIG. 6 illustrates a block diagram of a postage printing device 61 that can be used to print postage stamps or other indicium evidencing the payment of postage according to the present invention. The postage printing device 61 contains a processing unit 62 that is programmed to create the electronic color image files described above and sequentially output the data points contained in these electronic image files to a plurality of logic circuits 63. These logic circuits contain a plurality of AND, OR, NOT, and other logic gates that perform the logic functions defined by truth tables Table 1 or Table 2. The logic circuits 63 send their output to a printing device 64 which contains a plurality of individual print heads where there is one print head for each of the ink colors used in the printing process. FIG. 6 illustrates print heads 65c, 65m, 65y, 65k, for a four color printing process using cyan, magenta, yellow, and black inks. The present invention can also be used in printing devices employing different printing process having different numbers and colors of inks.

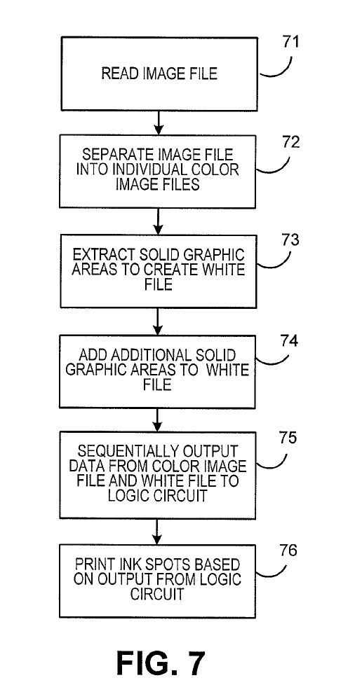

FIG. 7 illustrates a flow chart showing the processing steps performed by the processing unit 62 of the postage printing device 61. Processing begins with step 71 where the electronic image file 21 to be printed is read into the processing unit 62. The processing unit 61 then uses a Ripping algorithm at 72 to separate the color image file 21 into a set of individual color image files, one file for each color in the printing process. In a four color CMYK process this set of individual color image files corresponds to the four color files 23c, 23m, 23y, and 23k, described above. Next, data points defining the solid graphic areas, these are the areas occupied by any alphanumeric characters or other solid shapes, are extracted from the image file at 73 and added to the white file 25. As is often the case when printing postal indicium or postage stamps, the alphanumeric characters and other postal authority required solid shapes are not present in the image file 21. In those cases step 73 may be skipped and the processing unit proceeds directly from step 72 to step 74 where alphanumeric characters and other solid shapes are added to the white file 25. In step 75, the processing unit 62 then sequentially sends the data from each color file, 23c, 23m, 23y, 23k in the example above, along with the corresponding data from the white file 25, and if provided the fill file 51, to each of the respective logic circuits in the plurality of logic circuits 63. In step 76, the logic circuits 63 in turn send their output to the printing device 64 where the outputs are applied to the respective print head 65c, 65m, 65y, 65k which print ink spots on the media being printed resulting in a final printed color image having solid graphic areas with sharp edges and no leaking of colors from the background image into these solid graphic areas. It is also possible to eliminate the logic circuits 63 by programming the processing unit 62 to perform the logic defined in Table 1 or Table 2 and couple the outputs from the processing unit 62 directly to the inputs of the printing device 64.

The economical print heads available for printing color images with a postage machine do not have variable drop size or a high number of dots per inch. These economical printers therefore create ripped color images which blur the boundaries between solid colored characters and shapes and the background image. When printing on high throughput mailing machines, there is precious little time to compose and download data to the print heads between mail pieces. The present invention provides a way to noticeably reduce the blurring without significantly increasing the cost of the mailing machine.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A device for printing an image using a color printing process comprising:
a processing device programmed to separate a color image file representing the image to be printed into a plurality of single color image files, each single color image file corresponding to a different ink color being used to print the image, and create a white file containing data representing solid graphic areas to be included in the image;
a plurality of logic circuits coupled to the processing device, the plurality of logic circuits including one logic circuit for each ink color, each logic circuit having a first input coupled to receive data from a respective single color image file from the processing device, and a second input coupled to receive data from the white file from the processing device, each logic circuit in the plurality of logic circuits generating a first output signal whenever data in the white file indicates a solid graphic area is to appear in the image at a location, and a second output signal whenever data in the white file indicates that no solid graphic area is to appear in the image at a location; and
a printing device containing a plurality of print heads, one print head for each ink color being used to print the image; an input to each print head being coupled to an output of a respective logic circuit in the plurality of logic circuits, the print head adapted to not print an ink spot at a location when the first output signal is received from the respective logic circuit and to print an ink spot at a location when the second output signal is received from the respective logic circuit.

2. The device of claim 1, wherein the processing device creates the white file by extracting the solid graphic areas from the color image.

3. The device of claim 1, wherein the processing device creates the white file by adding the solid graphic areas to the white file.

4. The device of claim 1, wherein the device is a mail processing device and the image is printed on a mail piece.

5. A method for increasing edge sharpness in a color image printed on a medium comprising:
separating an image file representing the color image into a plurality of single color image files, each single color image file corresponding to a different ink color being used to print the color image, each of the single color image files containing data that defines locations where the ink color associated with that particular single color image file is to appear in the color image;
creating a white file containing data that defines locations where solid graphic areas are to appear in the color image;
combining the data from each file in the plurality of single color image files with the corresponding data from the white file to produce a first output signal whenever data in the white file indicates a solid graphic area is to appear in the color image at a location in the color image, and a second output signal whenever data in the white file indicates that no solid graphic area is to appear in the color image at a location in the color image;
providing the first and second output signals to a print head corresponding to the ink color of the single color image file; and
printing the color image on the medium based on the output received from the respective logic circuits, wherein the first output signal causes no ink to be printed at a location in the color image and the second output signal causes ink to be printed at a location in the color image.

6. The method of claim 5, wherein creating the white file comprises extracting the solid graphic images from the color image file.

7. The method of claim 5, wherein creating the white file comprises adding the solid graphic areas to the white file.

8. The method of claim 5, wherein combining the data from each file in the plurality of single color image files with the corresponding data from the white file further comprises:
feeding the data from each file in the plurality of single color image files to one input of a respective logic circuit corresponding to the ink color of the single color image file;
feeding corresponding data from the white file to a second input of the respective logic circuit; and
generating in each respective logic circuit the first output signal and the second output signal.

9. The method of claim 5 where the color image is an indicium evidencing payment of postage.

10. A device for printing an image using a color printing process comprising:
a processing device programmed to separate a color image file representing the image to be printed into a plurality of single color image files, each single color image file corresponding to a different ink color being used to print the image, create a white file containing data representing solid graphic areas to be included in the image, and create a plurality of fill color image files each corresponding to different color information to fill in the solid graphic areas contained in the white file;
a plurality of logic circuits coupled to the processing device, the plurality of logic circuits including one logic circuit for each ink color, each logic circuit having a first input coupled to receive data from a respective single color image file from the processing device, a second input coupled to receive data from the white file from the processing device, and a third input coupled to receive data from a respective one of the fill color image files from the processing device, each logic circuit in the plurality of logic circuits generating a first output signal whenever data in the white file and fill color image file indicates a filled solid graphic area is to appear in the image at a location or data in the single color image file indicates that the ink color is to appear in the image at a location and a second output signal whenever data in the fill color image file indicates that no filled solid graphic area is to appear at a location or data in the single color image file indicates that the ink color is not to appear in the image at a location; and
a printing device containing a plurality of print heads, one print head for each ink color being used to print the image; an input to each print head being coupled to an output of a respective logic circuit in the plurality of logic circuits, the print head adapted to print an ink spot when the first output signal is received from the respective logic circuit and not print an ink spot when the second output signal is received from the respective logic circuit.

11. The device of claim 10, wherein the processing device creates the white file by extracting the solid graphic areas from the color image.

12. The device of claim 10, wherein the processing device creates the white file by adding the solid graphic areas to the white file.

13. The device of claim 10, wherein the device is a mail processing device and the image is printed on a mail piece.

14. A method for increasing edge sharpness in a color image printed on a medium comprising:
separating an image file representing the color image into a plurality of single color image files, each single color image file corresponding to a different ink color being used to print the color image, each of the single color image files containing data that defines locations where the ink color associated with that particular single color image file is to appear in the color image;
creating a white file containing data that defines locations where solid graphic areas are to appear in the color image;
creating a plurality of fill color image files each corresponding to different color information to fill in the solid graphic areas contained in the white file;
combining corresponding data from each file in the plurality of single color image files, the white file, and a respective one of the fill color image files to produce a first output signal whenever data in the white file and fill color image file indicates a filled solid graphic area is to appear in the image of the indicium at a location or data in the single color image file indicates that the ink color is to appear in the image of the indicium at a location and a second output signal whenever data in the fill color image file indicates that no filled solid graphic area is to appear at a location or data in the single color image file indicates that the ink color is not to appear in the image of the indicium at a location;
providing the first and second output signals to a print head corresponding to the ink color of the single color image file; and
printing the color image on the medium based on the output received from the respective logic circuits, wherein the first output signal causes ink to be printed at a location in the color image and the second output signal causes no ink to be printed at a location in the color image.

15. The method of claim 14, wherein creating the white file comprises extracting the solid graphic images from the color image file.

16. The method of claim 14, wherein creating the white file comprises adding the solid graphic areas to the white file.

17. The method of claim 14, wherein combining the data from each file in the plurality of single color image files with the corresponding data from the white file further comprises:
feeding the data from each file in the plurality of single color image files to one input of a respective logic circuit corresponding to the ink color of the single color image file;
feeding the corresponding data from the white file to a second input of the respective logic circuit;
feeding corresponding data from the fill color image file to a third input of the respective logic circuit; and
generating in each respective logic circuit the first output signal and the second output signal.
